(19) United States
(12) Patent Application Publication
(10) Pub. No.: US 2023/0027448 A1
(43) Pub. Date: Jan. 26, 2023

(54) Frame Steered Vehicle

(71) Applicant: Eanna Pronsias Timoney, Inistioge (IE)

(72) Inventor: Eanna Pronsias Timoney, Inistioge (IE)

(21) Appl. No.: 17/782,219

(22) PCT Filed: Dec. 4, 2020
(86) PCT No.: PCT/EP2020/084739

§ 371 Date: Jun. 3, 2022

(30) Foreign Application Priority Data
Dec. 4, 2019 (GB) 1917692.4
Apr. 17, 2020 (IE) 2020/0064

(51) Int. Cl. B62D 12/00

(52) U.S. Cl. CPC B62D 12/00

(57) ABSTRACT

A frame steered vehicle (10) has a front chassis part (12) and a rear chassis part (13). An articulated coupling (11) connecting the front chassis part (12) and the rear chassis part (13) comprises a pair of spaced-apart rigid link arms (14, 15) mounted between a rear end of the front chassis part (12) and a front end of the rear chassis part (13), that is the link arms (14, 15) are connected at or adjacent the rear end of the front chassis part (12) and at or adjacent the front end of the rear chassis part (13). The link arms (14, 15) are offset to each side of the central longitudinal axis (AB) of the vehicle (10). Each link arm (14, 15) is pivotally connected to the front chassis part (12) by a pivot connector (16, 17) and pivotally connected to the rear chassis part (13) by a pivot connector (18, 19). The link arms (14, 15) are arranged in the form of an isosceles trapezoid. Operation of steering rams (6) extending between the front chassis part (12) and the rear chassis part (13) causes the vehicle parts (12, 13) to pivot relative to each other for steering the vehicle (10).

### CROSS REFERENCE TO RELATED APPLICATIONS

This application is a national phase to PCT Application No. PCT/EP2020/084739 filed Dec. 4, 2020 which in turn claims priority to Irish Application No. 2020/0064 filed Apr. 17, 2020 and UK Application No. 1917692.4 filed Dec. 4, 2019, wherein all said applications incorporated in their entirety herein by reference thereto.

### US GOVERNMENT SPONSORED RESEARCH AND DEVELOPMENT

None.

### BACKGROUND OF THE INVENTION

### 1. Field

This invention relates to frame steered vehicles.

### 2. Background

Conventional frame steer (articulated chassis) vehicles have a single pivot point, usually comprising a vertically oriented pin, between two chassis parts, typically a front chassis part and an associated rear chassis part typically forming a tractor and trailer combination, permitting articulation in the horizontal plane to provide steering of the vehicle. Unlike wheel steered vehicles generally the wheels on a frame steered vehicle are not individually steered except in some cases where additional wheel steering is sometimes provided to further reduce the turning circle.

It is well known to persons versed in the art that frame steered vehicles are inherently directionally unstable under certain circumstances that are commonly experienced in the normal expected course of operation of these vehicles. Such instability can pose a serious threat to the safe operation of these vehicles, even in the hands of experienced operators.

The kinematics of frame steer vehicles are such that movement of the steering wheel induces a yaw angular velocity in the rear chassis which is initially negative and becomes positive only after a few seconds. At higher speeds this can induce a weaving or snaking motion which is a lateral oscillation of the vehicle that can become unstable. Jack-knifing is another common instability mode of frame steer vehicles. Methods to ameliorate these effects include increasing the torsional stiffness and damping of the pivot, increasing the bulk modulus of the hydraulic oil in the steering to reduce destabilizing compressibility effects in the hydraulic system and greatly increasing the suspension stiffness or removing the suspension altogether. This latter approach, whist improving stability, increases the whole body vibration transmitted to the driver and has a negative effect on the general handline qualities of the vehicle.

Articulated steering imposes undesirable lateral accelerations on the driver due to the lateral displacement of the driver's seat. Lateral displacement of the centre of gravity when the chassis articulates also increases the likelihood of rollover.

Frame steering imposes large scrub loads on the tires leading to increased tire wear and increased wear and tear on the vehicle structure.

The present invention is aimed at eliminating or reducing these disadvantageous features and thus improving the overall stability and safety of frame steer vehicles. Other objects and purposes of the invention described below will be apparent to persons versed in the art.

EP3623179A2 discloses an articulated vehicle assembly having a “master and slave vehicle” arrangement. The coupling system constrains movement in the yaw plane e.g., the steering plane, allowing roll and pitch to facilitate going over humps and hollows. So there is in fact no articulated steering in this invention, the coupling is such as quote “to cause the vehicle articulated assembly 1 to behave somewhat as a rigid body in turns”. Directional control is effected by wheel steering on the front axle of the tractor and the axle of the slave.

U.S. Pat. No. 5,908,081A discloses a steering system which combines vehicle articulation with steerable movement of one axle of the vehicle. The articulation is of the standard single pivot type and the axle steering is a conventional wagon steer system.

GB1155847A discloses an articulated vehicle which has a single pivot point about which the two sections articulate. The disclosure relates to an armoured vehicle in which the two parts are respectively concave and convex so as to permit articulation when the parts are close coupled.

DE102014004681A1 discloses a conveyor train.

### SUMMARY OF THE INVENTION

This invention provides a linkage system between the front and rear chassis parts in place of the pivot pin provided in conventional frame steer vehicles. The linkage system is kinematically designed to transfer the turning centre of the front chassis part towards the front of the front chassis part to a virtual turning centre so as to provide a more optimized rotating point for the front chassis part when steering thus reducing the scrub loads on the tires and providing other benefits to handling as described below. The location of the virtual centre may be varied to meet specific requirements of the designer by varying the kinematic geometry of the linkage.

According to the invention, there is provided a frame steered vehicle comprising a front chassis part and a rear chassis part joined by an articulating coupling mechanism or linkage system, wherein the mechanism joining the two chassis parts is such that it creates a virtual kinematic centre in the front chassis part about which the front chassis part rotates.

In another embodiment of the invention, the frame steered vehicle includes: a front chassis part and an associated rear chassis part; and a steering mechanism connected between a rear end of the front chassis part and a front end of the rear chassis part; the steering mechanism comprising an articulated coupling between the front chassis part and the rear chassis part which allows relative pivoting of the front chassis part and the rear chassis part and an actuator or actuators which are operable to pivot the front chassis part relative to the rear chassis part to steer the vehicle; the articulated coupling comprising a pair of spaced-apart link arms mounted between the front chassis part and the rear chassis part, each link arm being pivotally connected to the front chassis part and to the rear chassis part.

In another embodiment, the articulated coupling is in the form of an isosceles trapezoid at zero steer angle.

In another embodiment, the link arms are length adjustable or wherein the distance between mounting lugs of the link arms is adjustable.

In another embodiment, the geometry of the link arms is adjustable.

In another embodiment, the vehicle has front wheels on the front chassis part and rear wheels on the rear chassis part and some or all wheels are driven by electric or hydraulic motors.

In another embodiment, the front wheels are steerable.

In another embodiment, the linkage comprises four identical link, bearing and mounting assemblies.

In another embodiment, the link arms are mounted on spherical bearings allowing angular movement in a vertical plane of the front chassis part in relation to the rear chassis part.

In another embodiment the linkage is such that the rear chassis/trailer can be readily attached or detached to enable various trailers to be used as is commonly done with a fifth wheel coupling connection.

In another embodiment the virtual pivot coupling is such that the rear chassis and front chassis may be attached and detached from each other.

In another embodiment a steering box is attached to the virtual steering pivot arm so as to steer the vehicle.

In another embodiment the steering actuating force is provided by a screw or ball screw actuator.

### BRIEF DESCRIPTION OF THE DRAWINGS

The invention will be more clearly understood by the following description of some embodiments thereof, given by way of example only, with reference to the accompanying drawings.

FIG. 1 is a plan view of a prior art frame steered articulated vehicle wherein FIG. 1a shows an articulated 6×6 dump truck and FIG. 1B shows an articulated 4×4 wheel loader.

FIG. 2 is a schematic plan view of a chassis element of frame steered vehicle according to the invention.

FIG. 3a is a comparison between a conventional single articulation pivot point and an articulated coupling linkage system in the frame steered vehicle according to the invention.

FIG. 3b shows an articulated 6×6 dump truck.

FIG. 3c shows an articulated 4×4 wheel loader.

FIG. 4 is a detail elevational view of an articulated coupling linkage system according to the invention.

FIG. 5 is an enlarged detail perspective view of a link arm of the articulated coupling linkage system.

FIG. 6 is a perspective view of another embodiment of the invention.

FIG. 7 is an elevation drawing of another embodiment of the invention.

FIG. 8 shows a typical example of prior art in the form of a fifth wheel coupling.

FIG. 9 shows an example of an embodiment of the invention which utilizes a similar attach/detach mechanism as a conventional fifth wheel coupling using twin vertical locking pins on the trailer.

FIG. 10 shows another version of the detachable coupling using horizontal locking pins.

FIG. 11 shows another virtual pivot linkage according to the invention.

### DETAILED DESCRIPTION OF THE EMBODIMENTS

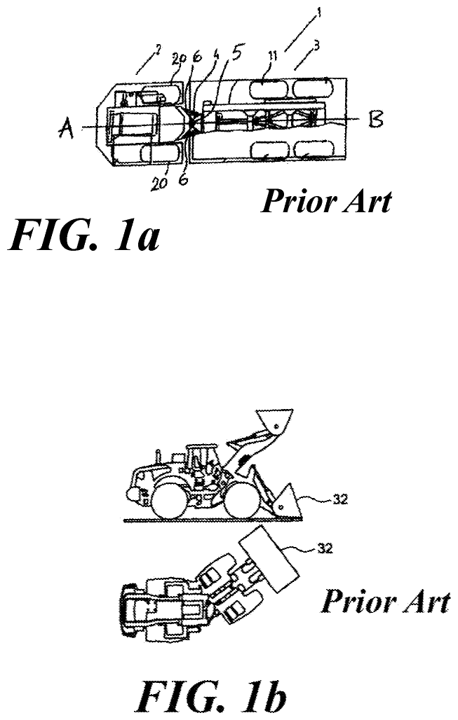

Referring initially to FIG. 1a, there is shown a conventional frame steered 6×6 articulated dump truck vehicle 1 comprising a front chassis part 2 which forms a tractor unit connected to an associated rear chassis part 3 which forms a trailer unit by an articulated coupling 4 having a single vertical pivot axis 5 located on a central longitudinal axis AB of the vehicle 1. An actuator is formed by steering rams 6 extending between the front chassis part 2 and the rear chassis part 3 at each side of the vertical pivot axis 5 which are operable to pivot the front chassis part 2 and the rear chassis part 3 about the vertical pivot axis 5. Similarly, FIG. 1B shows a conventional frame steer 4×4 wheel loader 32.

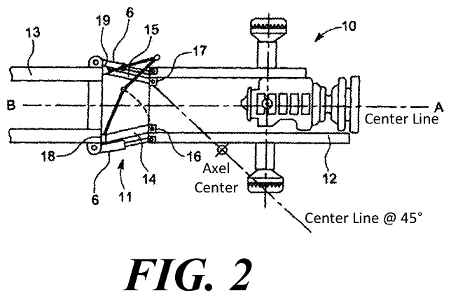

Referring now to FIG. 2, where is shown a chassis element of a frame steered vehicle according to the invention indicated generally by the reference numeral 10. Parts similar to those described previously are assigned the same reference numerals. The vehicle 10 has a front chassis part 12 and a rear chassis part 13. In accordance with the present invention, in this case an articulated coupling 11 connecting the front chassis part 12 and the rear chassis part 13 comprises a pair of spaced-apart rigid link arms 14, 15 mounted between a rear end of the front chassis part 12 and a front end of the rear chassis part 13, that is the link arms 14, 15 are connected at or adjacent the rear end of the front chassis part 12 and at or adjacent the front end of the rear chassis part 13.

The link arms 14, 15 are offset to each side of the central longitudinal axis AB of the vehicle 10. Each link arm 14, 15 is pivotally connected to the front chassis part 12 by a pivot connector 16, 17 and pivotally connected to the rear chassis part 13 by a pivot connector 18, 19. It will be noted that the link arms 14, 15 are arranged in the form of an isosceles trapezoid. Operation of the steering rams 6 extending between the front chassis part 12 and the rear chassis part 13 causes the vehicle parts 12, 13 to pivot relative to each other for steering the vehicle 10.

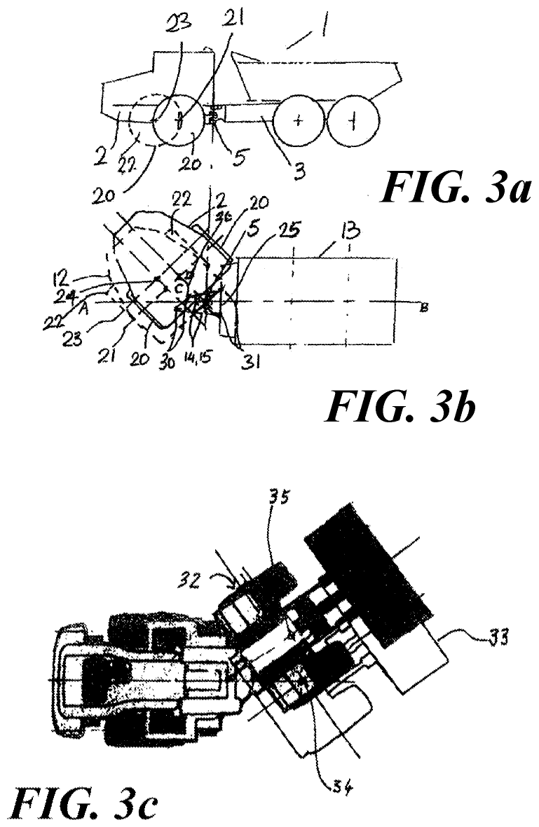

FIG. 3a shows an elevation and FIG. 3b a plan view of the articulated dump truck 1 with a conventional single vertical pivot axis 5 which joins the front chassis part 2 and the rear chassis part 3 whilst allowing the two chassis parts 2, 3 to articulate relative to each other about the vertical pivot axis 5. In order to reduce the steering forces on front wheels 20, a front axle 21 of the front chassis part 2 is customarily placed as close as possible to the vertical pivot axis 5. This creates difficulty in achieving an ideal weight distribution of the front chassis part 2 about the front wheels 20 with the result that the center of gravity of the front chassis part 2 is frequently forward of the front wheels 20 resulting in undesirable pitch and dive of the front chassis part 2 under braking and acceleration. Additionally, such unequal weight distribution places extra forces on the pivot pin bearings.

In the FIG. 3b plan view, the vehicle 1 is shown at a turning angle of 45 degrees. It can be seen that at this extreme angle the outer front wheel 20 is close to the centerline AB of the rear chassis part 3. Ideally, the outer front wheel 20 should not be allowed to pass the centerline AB of the rear chassis part 3, as this would cause instability and jeopardize the safety of the vehicle 1.

In the FIG. 3b plan view, a front chassis 12 in accordance with the invention is shown in dotted lines at an articulation angle of 45 degrees. This diagram is for illustrative purposes only and particularly to indicate that the center of rotation of the front chassis part 12 has moved forward of the original vertical pivot point 5 so that the front chassis 12 rotates in a manner such that the front axle centerline displacement from the rear chassis part 13 centerline A-B is greatly reduced. The center of the axle 21 of front chassis part 2 is indicated by point D and the center of axle 21 of the front chassis part 12 according to the invention is indicated by point C. It can be seen that the center point C has remained much closer to the centerline AB than the center point D for an extreme articulation angle of 45 degrees. For lesser angles of articulation as experienced in highway driving the position of the center point C remains substantially constant. In other words, the front axle rotates about the axle center with virtually zero lateral tire scrub. To improve the balance and stability of the vehicle the front axle 21 may be moved forward as shown in broken outline in FIG. 3a.

In the elevation view of FIG. 3a, the front wheel 20 has been moved forward to position 22 so that the weight of the front chassis part 2 is more favorably disposed over the axle centerline 23 compared to the original position of the wheel 20 and axle centerline 21. It can be seen in the plan view (FIG. 3b) that the new position of the center 24 of the new axle 23 is still within the safe parameters for stability whilst providing improved balance and reduced dive and pitch of the front chassis part 12, without increasing the turning radius of the vehicle.

In FIG. 3b, the multi-link articulated coupling mechanism comprises two link arms 14, 15 one end of each being pivotally mounted on the rear chassis part 13 about vertical axes 31 corresponding to the pivot connectors 18, 19 and the other ends being pivotally mounted on the front chassis 12 about vertical axes 30 corresponding to the pivot connectors 16, 17. The link arms 14, 15 are pivotally mounted on the front chassis part 12 and rear chassis part 13 in such a way that the linkage is in the form of an isosceles trapezoid at zero steer angle with a rearmost link 25 (between vertical axes 31) being located on or forming part of the front part of the rear chassis part 13 whilst a front link 26 (between vertical axes 30) forms a part of the front chassis 12. The rearmost link 25 is longer than the front link 26 such that the center of rotation of the front chassis part 12 is positioned forward of the rear of the front chassis part 12, the position of the center of rotation being dictated by the geometry of the isosceles trapezoid forming the coupling between the front chassis part 12 and the rear chassis part 13. By changing the geometry, the designer can locate the center of rotation at the most favorable point.

In FIG. 3c is shown a comparison between a conventional prior art 4×4 wheel loader 32 and a similar wheel loader 33 according to the invention at maximum turning angulation. It can be seen that the reduction in lateral movement of the center of gravity of the wheel loader 33 is even more pronounced compared to wheel loader 32 due to the fact that the axle center 34 in vehicle 33 does not move whereas the axle center 35 of conventional wheel loader 32 is displaced laterally causing a significant lateral displacement of the center of gravity of the front chassis part of vehicle 32 compared to the vehicle 33 according to the invention.

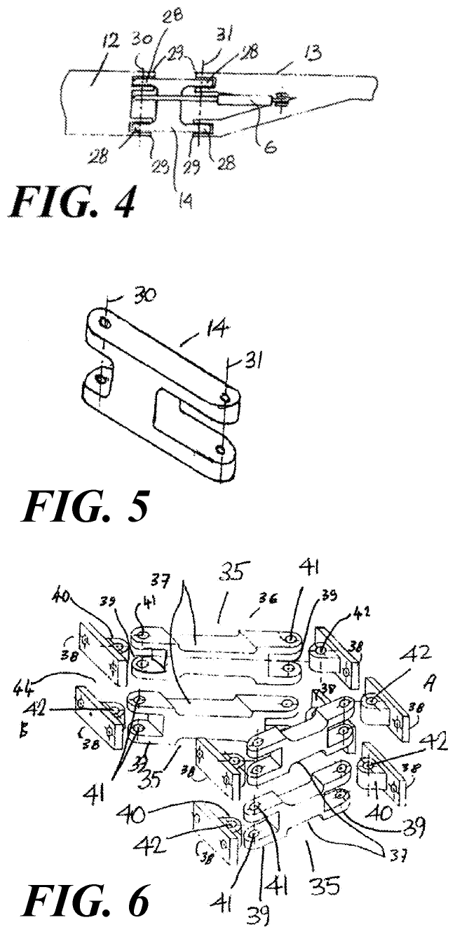

FIG. 4 shows a side elevation drawing of the steering link assembly of the invention. The front chassis part 3 and the rear chassis part 3 are connected by the pair of linkages 14, 15 (one only visible in the figure) which have bearing lugs 28 which correspond with matching lugs 29 in the front chassis part 12 and the rear chassis part 13. The lugs 28 or alternatively the lugs 29 contain suitable rotational bearings (not shown) to provide easy articulation of the chassis parts 12, 13. The articulation of the chassis is controlled by the two hydraulic steering rams 6 but it will be appreciated by ones versed in the art that other articulation means such as electrically powered ball screws may be used as convenient.

FIG. 5 shows a typical embodiment of the link arms 14, 15 showing vertical axes 30, 31 which correspond to vertical axes 30, 31 on the chassis lugs 29.

FIG. 6 shows a further embodiment of the invention linkage. In this embodiment a steering linkage 36 consists of four similar link assemblies 35 comprising link arms 37 and eight mounting brackets 38 four of which are attached to the front chassis part “A” (not shown) and four of which are attached to the rear chassis part “B” (not shown). Each of the links 37 have devises 39 at each end, which devises 39 fit onto corresponding lugs 40 on the mounting brackets 38. The devises 39 and the lugs 40 each have holes 41, 42 respectively which receive a suitable journal bearing (not shown) allowing the links 37 to pivot with respect to the brackets 38 about the journal mounted in the holes 41,42 which are fitted with a suitable journal bearing (not shown).

Among the advantages of this configuration are the possibility of having standalone assemblies forming units that can be bolted or otherwise attached to the front and rear assemblies. The geometry of the steering linkage can be adjusted to meet different requirements. Because of the multiplicity of identical elements, the cost of the linkage can be minimized. As there is no obstruction in the gap 44 between the upper and lower link assemblies 35 the possibility of interference with the propshaft between the front chassis part 12 and the rear chassis part 13 is eliminated.

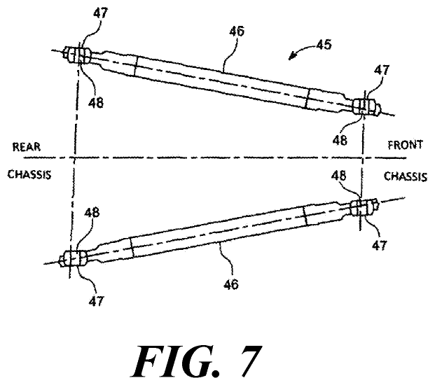

FIG. 7 is an elevation drawing 45 of another possible embodiment of the invention. With particular regard to a typical 6x6 articulated dump truck or other similar 6x6 articulated chassis large suspension movement is a desirable feature in order to ensure constant wheel contact with the terrain. In some cases, in traversing a mound of earth the front wheels may lose contact as the truck traverses the crown of the obstacle due to inadequate front suspension travel. In such cases vertical compliance between the front chassis and the rear chassis may be desirable to effectively increase the front wheel vertical travel in relation to the rear wheels. In the embodiment 45 link arms 46 are fitted to spherical ball bearings 47 such that the link arms 46 can move vertically about the center of the ball joint whilst having unrestricted pivotal movement about the bores 48 which are rotatably mounted in a suitable mounting (not shown) attached to the front and rear chassis members (not shown). The relative inclination of the link arms 46 in the elevation can control a virtual cab rotation center in the vertical plane to optimize the comfort of the driver. The spherical ball bearings 47 have the added advantage that the link arms 46 are subjected to only compression and tensile loads. The absence of bending loads in the link arms 46 enables a lighter and more cost effective assembly.

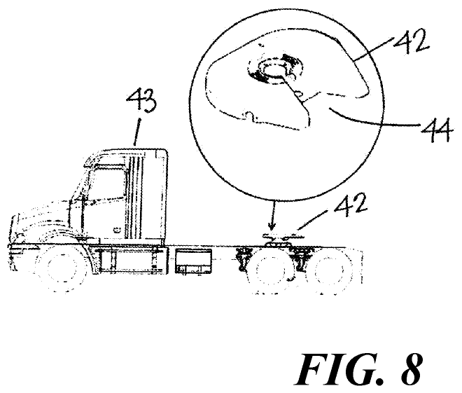

FIG. 8 shows a typical prior art fifth wheel coupling 42 which facilitates quick and secure attachment/detachment of a trailer unit (not shown) to a tractor unit 43. A pin situated in the landing area on the underside of the trailer slides into the Vee slot 44 in the fifth wheel 42 and triggers a locking mechanism that retains the pin enabling the trailer to be towed behind the tractor unit 43 whilst allowing rotation of the trailer about the pin axis.

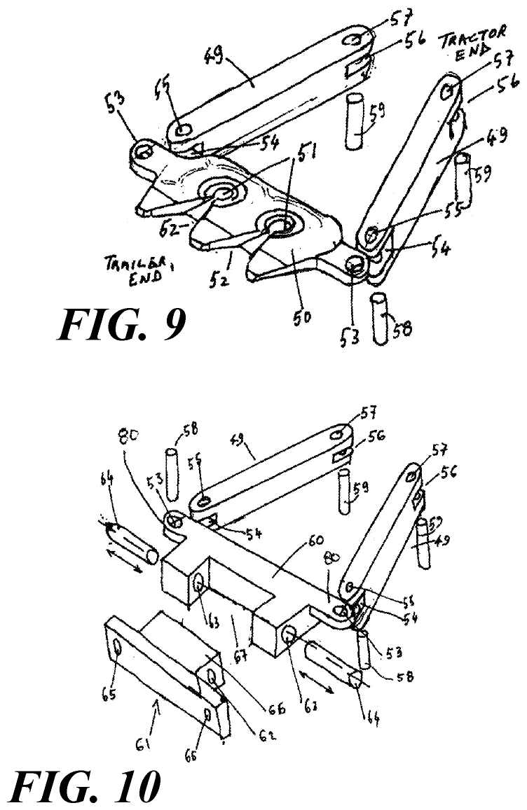

In FIG. 9 is shown an embodiment of the invention which is an adaptation of a commonly used fifth wheel coupling locking mechanism concept to the principle of the invention. A locking plate 50 comprises two holes 51 and two slots 52. The landing plate underneath the trailer (not shown) has two downwardly extending pins (not shown) that move through the guiding slots 52 when the tractor (not shown) is reversed into the trailer until the pins engage the holes 51 at which point a locking mechanism is activated to secure the trailer pins in the locating holes 51. The plate 50 is supported on a support plate (not shown) fixedly attached to the front chassis of the tractor unit which bears the load imposed by the trailer. The plate 50 is free to slide laterally on the aforementioned support plate which is suitably lubricated to reduce the sliding friction of the plate 50 on the above mentioned support plate.

The plate 50 has two laterally disposed holes 53 which are rotatably connected to link arms 49 by means of the devises 54 and pins 58 which are fitted to the holes 53 and associated holes 55 in the link arms 49 at one end. The other ends of the link arms 49 are also in the form of devises 56 which are rotatably connected to suitable tangs fixedly mounted to the tractor chassis (not shown) by means of the clevis pins 59 fitted into associated holes 57 in the link arms 49, thus permitting the link arms 49 to rotate about the axes of the holes 53 and 57 respectively. Thus, the link arms 49 are fixedly and rotatably attached to the tractor chassis.

The trailer (not shown) has two downwardly facing pins which engage the slots 52 as the tractor is reversed towards the trailer thus guiding said pins into the holes 51 wherein they are locked by the aforementioned fifth wheel type locking mechanism fixedly attaching the locking plate 50 to the trailer chassis. The assembly comprising the locking plate 50, fixedly attached to the trailer chassis, and the link arms 49 fixedly and rotatably attached to the tractor chassis by means of a suitable clevis plate (not shown) now form a virtual pivot linkage according to the invention.

It will be apparent to those versed in the art that the system shown in FIG. 9 is but one of many ways in which an attachable/detachable virtual pivot coupling can be accomplished within the scope of the invention. One such other example is shown in FIG. 10 in which the link arms 49 are attached to the tractor chassis as previously described by the devises 56 and the pins 59 fitted into the holes 57. At the trailer end the link arms 49 are rotatably attached to a locking plate 60 by means of tangs 80 with the holes 53 and the associated devises 54 and the securing pins 58 fitting into the holes 55. There is a mounting block 61 which is fixedly secured to the trailer chassis (not shown) representationally illustrated by the securing holes 65. When the tractor is reversed towards the trailer a mounting extension 66 of the block engages a slot 67 in the locking plate 60 and is locked in place automatically by insertion of pins 64 into holes 63 in the locking plate and into a hole 62 in the mounting extension 66 of block 61. A variety of means (not shown) may be used to automatically move and lock the pins 64 to attach and detach the trailer from the tractor. The slot 67 and the mounting extension 66 may be suitably tapered or otherwise configured as required to facilitate alignment of the trailer and the tractor unit when reversing the tractor to engage the coupling.

Another source of instability in articulated chassis vehicle is the steering actuation system, commonly two hydraulic rams which are mounted between the front and rear chassis. Extension of one ram and retraction of the other rotate the front and rear chassis relative to each other about the articulation pivot center. This system can cause or sustain steering instability due to various factors such as compressibility of the hydraulic system due to flexibility in the hoses, compressibility of the oil due to air entrainment or pressure imbalance between the two rams.

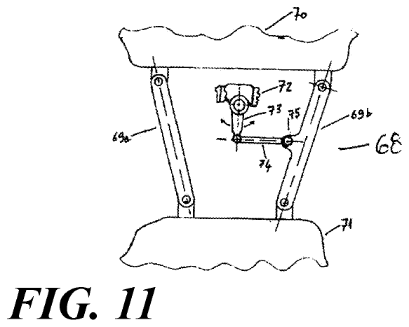

To eliminate these problems and to provide a more precise steering response the virtual pivot assembly may be fitted with a standard power assisted steering box such as commonly used in heavy vehicles. One illustrative example of such a system is shown in FIG. 11.

FIG. 11 depicts a virtual pivot linkage assembly 68 according to the invention. Two link arms 69a, 69b are each pivotally connected at one end to a rear chassis part 70 and at the other end to a front chassis part 71. A steering box 72 which may or may not be power assisted is fixed to either the front or rear chassis part 70, 71 as may be convenient. A steering arm 73 is rotatably mounted on the steering box 72 at one end and the other end of arm 73 is rotatably attached to a steering link 74. The other end of the steering link 74 is rotatably attached to the pivot link arm 69b by means of a suitable rod end bearing. Actuation of the steering box 72 rotates the pivot link arm 69b about its pivot thus steering the vehicle.

It will be apparent to those versed in the art that this is but one of many possible steering mechanisms that may accomplish the purpose within the scope of the invention, for example a suitable ball screw actuator may be used in place of the steering box described. Also, it will be evident that if more steering power is required another slave steering box may be fitted to link arm 69a.

It will be appreciated that a further variety of linkage configurations may be used to accomplish the objects of the invention.

It will further be appreciated that the virtual kinematic steering center may be positioned in the rear chassis part or in the front chassis part as described.

The terms “comprise” and “include”, and any variations thereof required for grammatical reasons, are to be considered as interchangeable and accorded the widest possible interpretation.

The invention is not limited to the embodiments hereinbefore described which may be varied in both construction and detail within the scope of the appended claims.

1. A frame steered articulated chassis vehicle comprising a front chassis part and a rear chassis part joined by an articulating coupling mechanism, wherein the mechanism joining the two chassis parts is such that it creates a virtual kinematic center in the front chassis part about which the front chassis part rotates.

2. The frame steered vehicle as claimed in claim 1, including:
a front chassis part and an associated rear chassis part,
a steering mechanism connected between a rear end of the front chassis part and a front end of the rear chassis part,
the steering mechanism comprising an articulated coupling between the front chassis part and the rear chassis part which allows relative pivoting of the front chassis part and the rear chassis part and an actuator or actuators which are operable to pivot the front chassis part relative to the rear chassis part to steer the vehicle,
the articulated coupling comprising a pair of spaced-apart link arms mounted between the front chassis part and the rear chassis part, each link arm being pivotally connected to the front chassis part and to the rear chassis part.

3. The frame steered vehicle as claimed in claim 1, wherein the articulated coupling is in the form of an isosceles trapezoid at zero steer angle.

4. The frame steered vehicle as claimed in claim 2, wherein the link arms are length adjustable or wherein the distance between mounting lugs of the link arms is adjustable.

5. The frame steered vehicle as claimed in claim 1, wherein the geometry of the link arms is adjustable.

6. The frame steered vehicle as claimed in claim 1, wherein the vehicle has front wheels on the front chassis part and rear wheels on the rear chassis part and some or all wheels are driven by electric or hydraulic motors.

7. The frame steered vehicle as claimed in claim 1, wherein the vehicle has front wheels on the front chassis part and the front wheels are steerable.

8. The frame steered vehicle as claimed in claim 1, wherein the linkage comprises four identical link, bearing and mounting assemblies.

9. The frame steered vehicle as claimed in claim 1, wherein the link arms are mounted on spherical bearings allowing angular movement in a vertical plane of the front chassis part in relation to the rear chassis part.

10. The frame steered vehicle as claimed in claim 1, wherein the virtual pivot coupling is such that the rear chassis and front chassis may be attached and detached from each other.

11. The frame steered vehicle as claimed in claim 1, wherein a steering box is attached to the virtual steering pivot arm so as to steer the vehicle.

12. The frame steered vehicle as claimed in claim 1, wherein the steering actuating force is provided by a screw or ball screw actuator.
